(19) United States
(12) Patent Application Publication
(10) Pub. No.: US 2009/0159590 A1
(43) Pub. Date: Jun. 25, 2009

(54) SUBSTRATE TEMPERATURE ADJUSTING-FIXING DEVICES

(75) Inventors: Hiroshi Yonekura, Nagano-shi (JP); Tomoaki Koyama, Nagano-shi (JP); Koki Tamagawa, Nagano-shi (JP)

Correspondence Address: RANKIN, HILL & CLARK LLP, 38210 Glenn Avenue, WILLOUGHBY, OH, 44094-7808, US

(73) Assignee: SHINKO ELECTRIC INDUSTRIES CO., LTD., Nagano-shi (JP)

(21) Appl. No.: 12/332,705

(22) Filed: Dec. 11, 2008

(30) Foreign Application Priority Data
Dec. 21, 2007 (JP) 2007-330600

(51) Int. Cl. H05B 3/06

(52) U.S. Cl. 219/520

(57) ABSTRACT

A substrate temperature adjusting-fixing device 10 includes an electrostatic chuck 11 which is provided with a base body 21 having a substrate placement surface 21A for placing s substrate 20 thereon, an electrostatic electrode 22 embedded in the base body 21, and a resistance heater 23 embedded in the base body 21 to heat the substrate 20; and a base plate 12 which is provided with a cooling mechanism 46 for cooling the electrostatic chuck 11 and supports the electrostatic chuck 11, in which a heat insulation portion 47 is provided in a base plate body 45 at a portion located between the cooling mechanism 46 and the electrostatic chuck 11.

### BACKGROUND OF THE INVENTION

The present invention relates to a substrate temperature adjusting-fixing device, and more particularly, to a substrate temperature adjusting-fixing device provided with an electrostatic chuck having a base body and a resistance heater embedded in the base body to heat a substrate.

In a manufacture device such as a coating device for forming a coating on a substrate such as a glass substrate or a semiconductor substrate or an etching device for patterning the coating formed on the substrate, a substrate temperature adjusting-fixing device is provided so as to adjust a temperature of a substrate adsorbed and fixed to a base body at a predetermined temperature (see FIG. 1).

FIG. 1 is a cross sectional view showing a substrate temperature adjusting-fixing device according to a conventional art.

As shown in FIG. 1, a substrate temperature adjusting-fixing device 300 according to the conventional art includes an electrostatic chuck 301 and a base plate 302. The electrostatic chuck 301 includes a base body 305, an electrostatic electrode 306, and resistance heaters 307. The base body 305 is disposed on the base plate 302. The base body 305 includes a substrate placement surface 305A for placing a substrate 303 thereon. As a material of the base body 305, for example, ceramic may be used.

The electrostatic electrode 306 is a thin-film electrode. The electrostatic electrode 306 is embedded in the base body 305 at a position in the vicinity of the substrate placement surface 305A. The electrostatic electrode 306 is an electrode for fixing the substrate 303 onto the base body 305 (specifically, the substrate placement surface 305A) upon being applied with a voltage.

The resistance heaters 307 are embedded in the base body 305 at a position below the electrostatic electrode 306. The resistance heaters 307 are formed by an interconnection pattern (not shown). The resistance heaters 307 are heated upon being applied with a voltage and heats the substrate placement surface 305A (in other words, the substrate 303 via the substrate placement surface 305A) in terms of the heating.

The base plate 302 includes a base plate body 311 and a cooling mechanism 312. The base plate body 311 is used to support the electrostatic chuck 301. As a material of the base plate body 311, for example, Al may be used. The cooling mechanism 312 includes conduit lines 314, a cooling water introduction portion 315, and a cooling water discharge portion 316. The conduit lines 314 are embedded in the base plate body 311. The conduit lines 314 are used to circulate cooling water. The cooling water flowing to the conduit lines 314 cools the base body 305, thereby adjusting the temperature of the substrate placement surface 305A.

The cooling water introduction portion 315 is provided on the side of the lower surface of the base plate body 311. The cooling water introduction portion 315 is used to introduce the cooling water into the conduit lines 314. The cooling water discharge portion 316 is provided on the side of the lower surface of the base plate body 311. The cooling water discharge portion 316 is used to discharge the cooling water of which a temperature is increased to the outside of the base plate body 311 (for example, see Patent Document 1).

### [Patent Document 1] JP-A-2005-26120

However, a temperature of the base plate body 311 at a portion located in the vicinity of the cooling water introduction portion 315 becomes lower than that of the base plate body 311 located at different positions due to an influence of the temperature of the cooling water introduced into the cooling water introduction portion 315. Accordingly, a temperature of the substrate 303 at a portion located above the cooling water introduction portion 315 becomes lower than that of the substrate 303 located at different positions. For this reason, in the substrate temperature adjusting-fixing device 300 according to the conventional art, a problem arises in that the whole substrate 303 cannot be heated up to a predetermined temperature.

Additionally, since a heat of the base body 305 easily moves to the base plate 302, a problem arises in that it takes much time to heat the substrate placement surface 305A up to a predetermined temperature.

Additionally, although it may be supposed that the substrate placement surface 305A is heated up to a predetermined temperature by applying a high voltage to the resistance heaters 307, in this case, a high current flows to a circuit of the resistance heaters 307, thereby causing a problem in that the resistance heaters 307 are broken.

### SUMMARY OF THE INVENTION

Therefore, an object of the invention is to provide a substrate temperature adjusting-fixing device capable of heating a whole substrate up to a predetermined temperature in a short time.

According to a first aspect of the invention, there is provided a substrate temperature adjusting-fixing device including:

an electrostatic chuck which includes a base body having a substrate placement surface for placing a substrate thereon, an electrostatic electrode embedded in the base body, and a resistance heater embedded in the base body to heat the substrate,

a base plate which includes a base plate body for supporting the electrostatic chuck and a cooling mechanism embedded in the base plate body to cool the base body, and

a heat insulation portion provided in the base plate body at a portion located between the cooling mechanism and the electrostatic chuck.

According to a second aspect of the invention, there is provided the substrate temperature adjusting-fixing device according to the first aspect, wherein

the cooling mechanism includes a conduit line for allowing a cooling water to flow therethrough and a cooling water introduction portion for introducing the cooling water into the conduit line, and

the heat insulation portion is disposed so as to be opposed to the cooling mechanism.

According to a third aspect of the invention, there is provided the substrate temperature adjusting-fixing device according to the first or second aspect, wherein

the heat insulation portion is a space formed in the base plate body.

According to a forth aspect of the invention, there is provided the substrate temperature adjusting-fixing device according to the third aspect, wherein the space is in a vacuum state.

According to a fifth aspect of the invention, there is provided the substrate temperature adjusting-fixing device according to the third aspect, wherein an inert gas of which a pressure is adjusted to be a predetermined pressure is introduced into the space.

According to a sixth aspect of the invention, there is provided the substrate temperature adjusting-fixing device according to the fifth aspect, wherein

the inert gas is a helium gas.

According to a seventh aspect of the invention, there is provided the substrate temperature adjusting-fixing device according to any one of the first to sixth aspects, further including:

a uniform heat plate provided between the electrostatic chuck and the base plate.

According to an eighth aspect of the invention, there is provided the substrate temperature adjusting-fixing device according to any one of the first to seventh aspects, further including:

a heater portion for heating the substrate provided in the base plate body at a portion located between the heat insulation portion and the cooling mechanism.

According to the invention, since the heat insulation portion is provided in the base plate body at a portion located between the cooling mechanism and the electrostatic chuck, it is possible to restrict the heat from moving between the base body and the base plate body and thus to heat a whole substrate up to a predetermined temperature in a shorter time than that of the conventional art.

According to the invention, it is possible to heat a whole substrate up to a predetermined temperature in a shorter time than that of the conventional art.

### BRIEF DESCRIPTION OF THE DRAWINGS

FIG. 1 is a cross sectional view showing a substrate temperature adjusting-fixing device according to a conventional art.

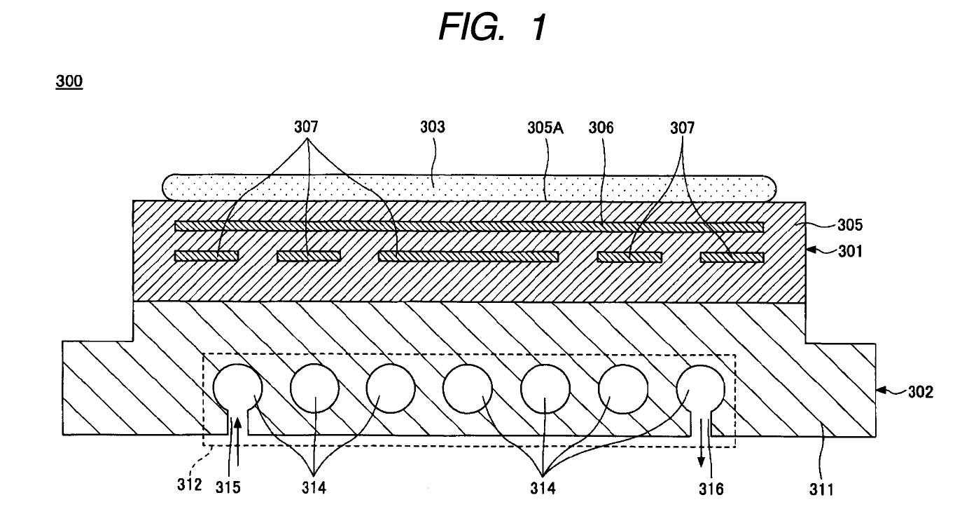

FIG. 2 is a cross sectional view showing the substrate temperature adjusting-fixing device according to a first embodiment of the invention.

FIG. 3 is a top view showing a resistance heater shown in FIG. 2.

FIG. 4 is a cross sectional view showing the substrate temperature adjusting-fixing device according to a first modified example of the first embodiment of the invention.

FIG. 5 is a cross sectional view showing the substrate temperature adjusting-fixing device according to a second modified example of the first embodiment of the invention.

FIG. 6 is a cross sectional view showing the substrate temperature adjusting-fixing device according to a second embodiment of the invention.

### DETAILED DESCRIPTION OF THE PREFERRED EMBODIMENTS

Next, exemplary embodiments of the invention will be described with reference to the accompanying drawings.

### First Embodiment

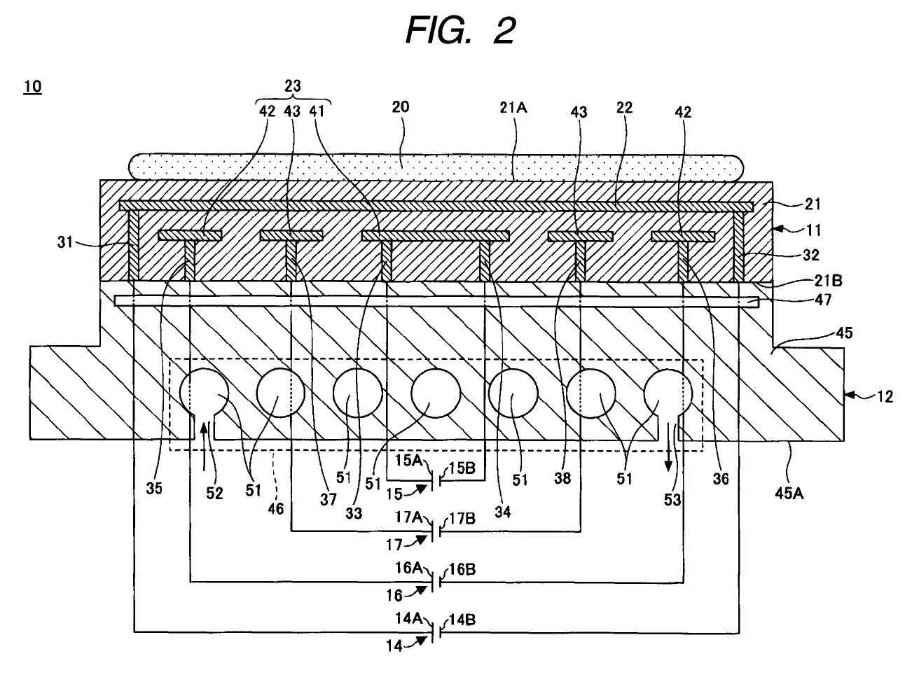

FIG. 2 is a cross sectional view showing a substrate temperature adjusting-fixing device according to the first embodiment of the invention.

As shown in FIG. 2, a substrate temperature adjusting-fixing device 10 includes an electrostatic chuck 11, a base plate 12, and power sources 14 to 17.

The electrostatic chuck 11 includes a base body 21, an electrostatic electrode 22, a resistance heater 23, and electrodes 31 to 38. The base body 21 is adhered onto the base plate 12. The base body 21 includes a substrate placement surface 21A for placing a substrate 20 thereon. As a material of the base body 21, for example, ceramic may be used. In the case where the ceramic is used as the material of the base body 21, the base body 21 is formed, for example, by burning a plurality of laminated green sheets (not shown). Additionally, as the substrate 20, for example, a glass substrate or a semiconductor substrate (for example, a silicon substrate) may be used.

The electrostatic electrode 22 is an electrode with a thin-film shape. The electrostatic electrode 22 is embedded in the base body 21 at a position in the vicinity of the substrate placement surface 21A. The electrostatic electrode 22 is connected to the electrodes 31 and 32. The electrostatic electrode 22 is electrically connected to a power source 14 via the electrodes 31 and 32. The electrostatic electrode 22 fixes the substrate 20 onto the substrate placement surface 21A in terms of an electrostatic force generated upon being applied with a voltage from the power source 14. As a material of the electrostatic electrode 22, for example, tungsten or molybdenum may be used.

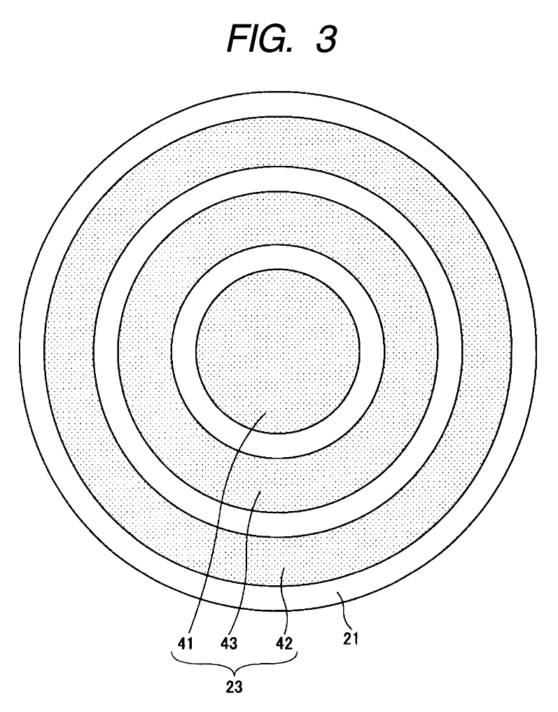

FIG. 3 is a top view showing the resistance heater shown in FIG. 2.

As shown in FIGS. 2 and 3, the resistance heater 23 is constituted by first to third resistance heaters 41 to 43. The first to third resistance heaters 41 to 43 are embedded in the base body 21 at a position located below the electrostatic electrode 22. The first to third resistance heaters 41 to 43 are disposed on the same plane. The first to third resistance heaters 41 to 43 are electrically insulated from the electrostatic electrode 22.

The first resistance heater 41 is embedded in the central portion of the base body 21. The first resistance heater 41 is connected to the electrodes 33 and 34. The first resistance heater 41 is electrically connected to the power source 15 via the electrodes 33 and 34. The first resistance heater 41 is heated upon being applied with a voltage by the power source 15. The first resistance heater 41 is used to heat the substrate placement surface 21A at a position corresponding to the central portion of the substrate 20.

The second resistance heater 42 is embedded in the outer peripheral portion of the base body 21. The second resistance heater 42 is connected to the electrodes 35 and 36. The second resistance heater 42 is electrically connected to the power source 16 via the electrodes 35 and 36. The second resistance heater 42 is heated upon being applied with a voltage by the power source 16. The second resistance heater 42 is used to heat the substrate placement surface 21A at a position corresponding to the outer peripheral portion of the substrate 20.

The third resistance heater 43 is embedded in the base body 21 between the first resistance heater 41 and the second resistance heater 42. The third resistance heater 43 is connected to the electrodes 37 and 38. The third resistance hater 43 is electrically connected to the power source 17 via the electrodes 37 and 38. The third resistance heater 43 is heated upon being applied with a voltage by the power source 17. The third resistance hater 43 is used to heat the substrate placement surface 21A at a position corresponding to a portion between the central portion and the outer peripheral portion of the substrate 20.

The resistance heater 23 with the above-described configuration is used to heat the substrate placement surface 21A of the base body 21 up to a predetermined temperature in terms of a plurality of resistance heaters (in this case, the first to third resistance heaters 41 to 43). The resistance heater 23 is capable of heating the substrate placement surface 21A of the base body 21 up to a temperature in the range of 250° C. to 300° C.

Additionally, although the first to third resistance 2, heaters 41 to 43 are simply shown in FIGS. 2 and 3, the first to third resistance heaters 41 to 43 are respectively formed by an interconnection pattern. Although a case has been described in which the resistance heater 23 is constituted by three resistance heaters (the first to third resistance heaters 41 to 43) in FIGS. 2 and 3, the number of the resistance heaters constituting the resistance heater 23 may be one, two, or three or more.

The electrodes 31 and 32 are formed through the base body 21 at a portion located below the electrostatic electrode 22. The electrode 31 is electrically connected to a plus terminal 14A of the power source 14. The electrode 32 is electrically connected to a minus terminal 14B of the power source 14. As a material of the electrodes 31 and 32, for example, tungsten or molybdenum may be used.

The electrodes 33 and 34 are formed through the base body 21 at a portion located below the first resistance heater 41. The electrode 33 is electrically connected to a plus terminal 15A of the power source 15. The electrode 34 is electrically connected to a minus terminal 15B of the power source 15. As a material of the electrodes 33 and 34, for example, tungsten or molybdenum may be used.

The electrodes 35 and 36 are formed through the base body 21 at a portion located below the second resistance heater 42. The electrode 35 is electrically connected to a plus terminal 16A of the power source 16. The electrode 36 is electrically connected to a minus terminal 16B of the power source 16. As a material of the electrodes 35 and 36, for example, tungsten or molybdenum may be used.

The electrodes 37 and 38 are formed through the base body 21 at a portion located below the third resistance heater 43. The electrode 37 is electrically connected to a plus terminal 17A of the power source 17. The electrode 38 is electrically connected to a minus terminal 17B of the power source 17. As a material of the electrodes 37 and 38, for example, tungsten or molybdenum may be used.

The base plate 12 includes a base plate body 45, a cooling mechanism 46, and a heat insulation portion 47. The base plate body 45 is provided on the side of a lower surface 21B of the base body 21. The base plate body 45 is used to support the electrostatic chuck 11. As a material of the base plate body 45, metal may be used. As the metal used as the material of the base plate body 45, for example, Al may be used.

The cooling mechanism 46 includes conduit lines 51, a cooling water introduction portion 52, and a cooling water discharge portion 53. The conduit lines 51 are embedded in the base plate body 45. The conduit lines 51 are used to circulate (move) the cooling water. The cooling mechanism 46 cools the base body 21 in terms of the cooling water flowing to the conduit lines 51, thereby adjusting the temperature of the substrate placement surface 21A so as to be a predetermined temperature.

The cooling water introduction portion 52 is provided on the side of a lower surface 45A of the base plate body 45. The cooling water introduction portion 52 is connected to the conduit lines 51 in a state capable of supplying the cooling water to the conduit lines 51. The cooling water introduction portion 52 is an introduction port for introducing the cooling water into the conduit lines 51.

The cooling water discharge portion 53 is provided on the side of the lower surface 45A of the base plate body 45. The cooling water discharge portion 53 is a discharge port for discharging the cooling water of which a temperature is increased to the outside of the base plate body 45.

The heat insulation portion 47 is embedded in the base plate body 45 at a position between the electrostatic chuck 11 and the cooling mechanism 46. The heat insulation portion 47 is disposed so as to be opposed to the cooling mechanism 46. The heat insulation portion 47 is a space formed in the base plate body 45. The space forming the heat insulation portion 47 is in a vacuum state. A shape of the heat insulation portion 47 may be, for example, a cylindrical shape. In this case, a height of the heat insulation portion 47 may be, for example, in the range of 2 mm to 5 mm.

Likewise, with such a configuration in which the heat insulation portion 47 is embedded in the base plate body 45 at a portion located between the electrostatic chuck 11 and the cooling mechanism 46 and the heat insulation portion 47 is disposed so as to be opposed to the cooling mechanism 46, it is possible to restrict the heat from moving between the base body 21 and the base plate body 45. Accordingly, it is possible to heat the whole substrate 20 up to a predetermined temperature in a shorter time than that of the conventional art.

The power source 14 includes the plus terminal 14A and the minus terminal 14B. The plus terminal 14A is electrically connected to the electrode 31, and the minus terminal 14B is electrically connected to the electrode 32.

The power source 15 includes the plus terminal 15A and the minus terminal 15B. The plus terminal 15A is electrically connected to the electrode 33, and the minus terminal 15B is electrically connected to the electrode 34.

The power source 16 includes the plus terminal 16A and the minus terminal 16B. The plus terminal 16A is electrically connected to the electrode 35, and the minus terminal 16B is electrically connected to the electrode 36.

The power source 17 includes the plus terminal 17A and the minus terminal 17B. The plus terminal 17A is electrically connected to the electrode 37, and the minus terminal 17B is electrically connected to the electrode 38.

According to the substrate temperature adjusting-fixing device of this embodiment, since the heat insulation portion 47 is embedded in the base plate body at a portion located between the electrostatic chuck 11 and the cooling mechanism 46 so as to be opposed to the cooling mechanism 46, it is possible to restrict the heat from moving between the base body 21 and the base plate body 45. Accordingly, it is possible to heat the whole substrate 20 up to a predetermined temperature in a shorter time than that of the conventional art.

Additionally, in this embodiment, although a case has been described in which the heat insulation portion 47 having one space is provided, the heat insulation portion 47 may have two or more spaces. A shape of the heat insulation portion 47 is not limited to the shape of the heat insulation portion 47 according to this embodiment.

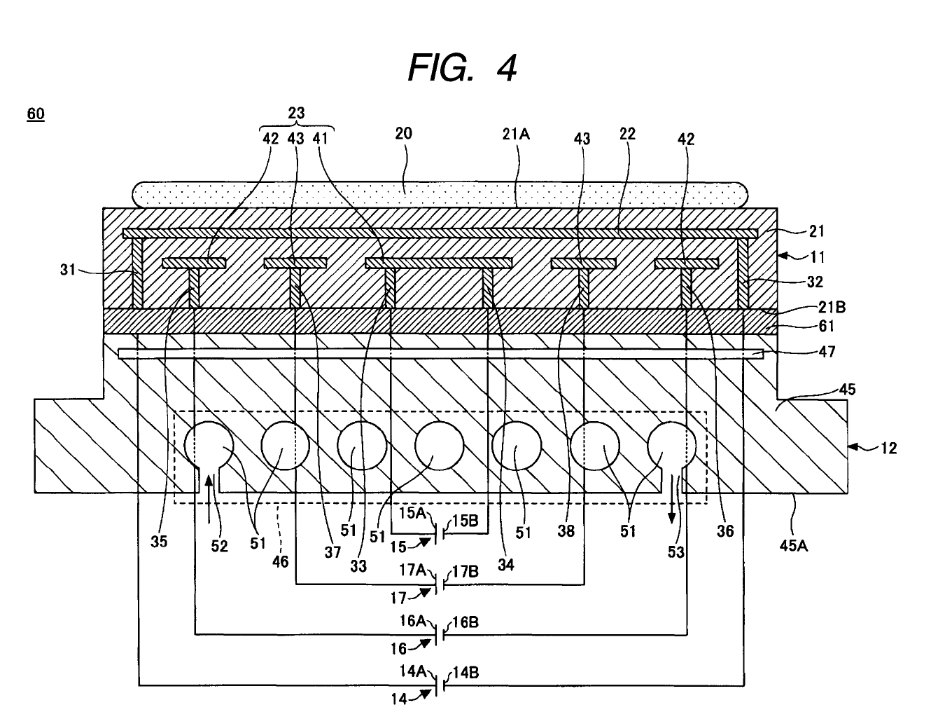

FIG. 4 is a cross sectional view showing the substrate temperature adjusting-fixing device according to a first modified example of the first embodiment of the invention. In FIG. 4, the same reference numerals are given to the same components as those of the substrate temperature adjusting-fixing device 10 according to the first embodiment.

As shown in FIG. 4, a substrate temperature adjusting-fixing device 60 according to the first modified example of this embodiment has the same configuration as that of the substrate temperature adjusting-fixing device 10 except that a uniform heat plate 61 is further provided in the configuration of the substrate temperature adjusting-fixing device 10 according to this embodiment.

The uniform heat plate 61 is disposed between the lower surface of the electrostatic chuck 11 and the upper surface of the base plate 12. The uniform heat plate 61 is adhered to the electrostatic chuck 11 and the base plate 12 by use of an adhesive. The uniform heat plate 61 is a member for allowing the temperature of the whole substrate 20 heated by the resistance heater 23 so as to be substantially uniform. As a material of the uniform heat plate 61, for example, aluminum may be used. In the case where the aluminum is used as the material of the uniform heat plate 61, a thickness of the uniform heat plate 61 may be set to, for example, 2 mm.

Likewise, with such a configuration in which the uniform heat plate 61 is provided between the electrostatic chuck 11 having the electrostatic chuck 22 and the resistance heater 23 embedded therein and the base plate 12 having the heat insulation portion 47, it is possible to decrease the non-uniformity of the temperature of the whole substrate 20 heated by the resistance heater as small as possible. Additionally, the substrate temperature adjusting-fixing device 60 according to the first modified example of this embodiment is capable of obtaining the same advantage as that of the substrate temperature adjusting-fixing device 10 according to this embodiment.

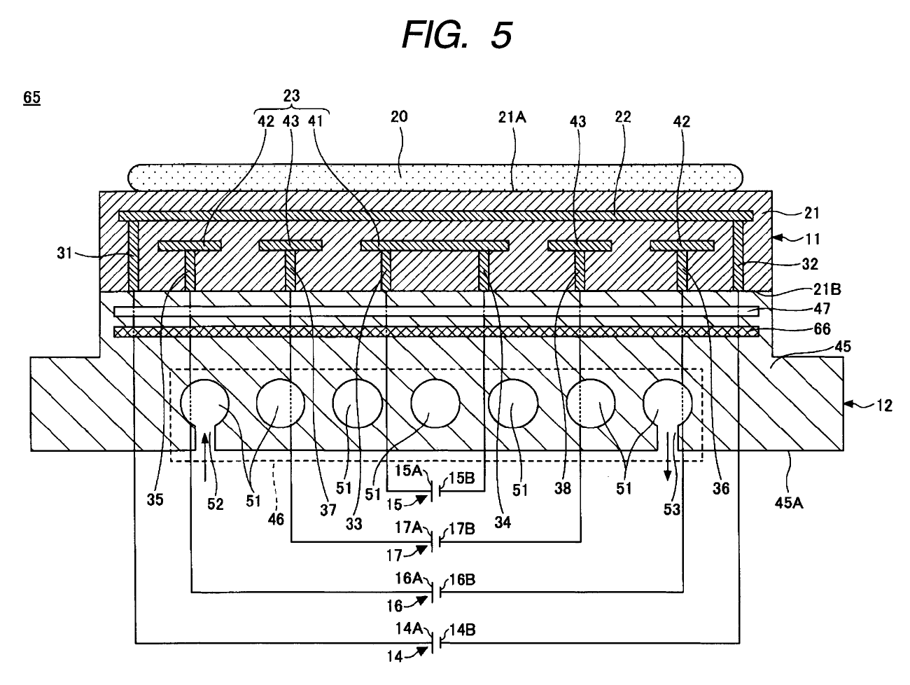

FIG. 5 is a cross sectional view showing the substrate temperature adjusting-fixing device according to a second modified example of the first embodiment of the invention. In FIG. 5, the same reference numerals are given to the same components as those of the substrate temperature adjusting-fixing device 10 according to the first embodiment.

As shown in FIG. 5, a substrate temperature adjusting-fixing device 65 according to the second modified example of this embodiment has the same configuration as that of the substrate temperature adjusting-fixing device 10 except that a heater portion 66 is further provided in the configuration of the substrate temperature adjusting-fixing device 10 according to this embodiment.

The heater portion 66 is embedded in the base plate body 45 at a portion located between the heat insulation portion 47 and the cooling mechanism 46. The heater portion 66 is used to heat the substrate 20 up to a predetermined temperature together with the resistance heater 23. As the heater portion 66, for example, a sheath heater may be used which includes a pair of terminals, a heater connected to the pair of terminals (for example, a nichrome wire), and a metal external pipe for covering the heater. As a material of the metal external pipe, for example, copper, stainless, titanium, or the like may be used. As another heater instead of the sheath heater, for example, a cartridge heater, a plate heater, or the like may be used.

Likewise, with such a configuration in which the heater portion 66 is embedded in the base plate body 45 at a portion located between the heat insulation portion 47 and the cooling mechanism 46, it is possible to heat the substrate placement surface 21A up to a temperature in the range of 450° C. to 500° C. or so (in other words, it is possible to heat the substrate 20 up to a temperature in the range of 450° C. to 500° C.). Accordingly, for example, in the case where the substrate temperature adjusting-fixing device 65 is provided in a CVD (Chemical Vapor Deposition) device or a PVD (Physical Vapor Deposition) device, it is possible to form a satisfactory coating (for example, a tungsten coating) on the whole surface of the substrate 20 under a process condition in a temperature range 450° C. to 500° C. or so. Additionally, the substrate temperature adjusting-fixing device 65 according to the second modified example of this embodiment is capable of obtaining the same advantage as that of the substrate temperature adjusting-fixing device 10 according to this embodiment.

### Second Embodiment

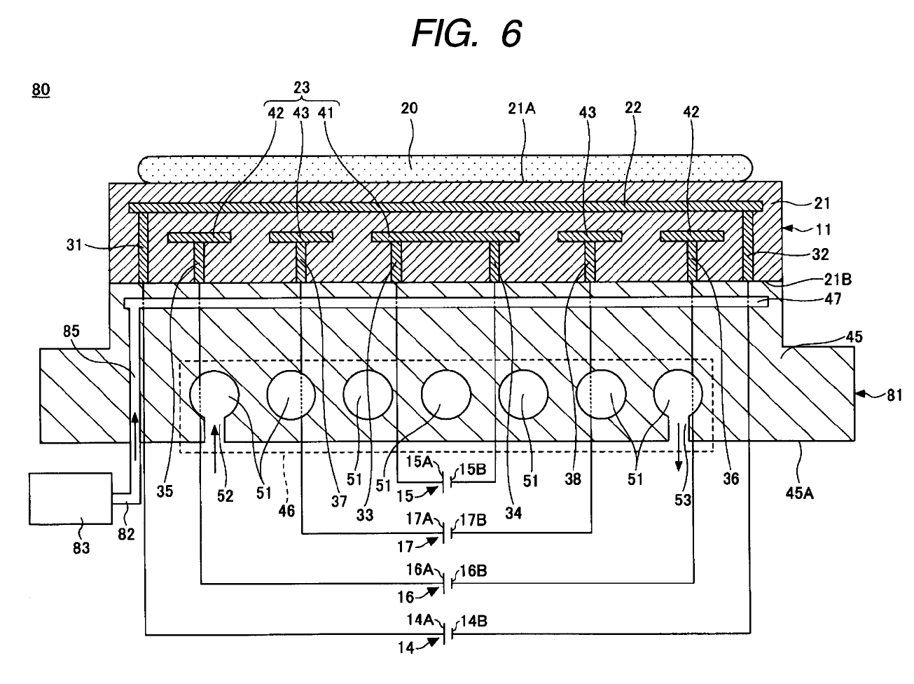

FIG. 6 is a cross sectional view showing the substrate temperature adjusting-fixing device according to the second embodiment of the invention.

As shown in FIG. 6, a substrate temperature adjusting-fixing device 80 according to the second embodiment has the same configuration as that of the substrate temperature adjusting-fixing device 10 except that a base plate 81 is provided instead of the base plate 12 provided in the substrate temperature adjusting-fixing device 10 according to the first embodiment and an inert gas supply conduit line 82 and an inert gas supply device 83 are further provided.

The base plate 81 has the same configuration as that of the base plate 12 except that the inert gas supply conduit line 85 is further provided in the configuration of the base plate 12 (see FIG. 2).

The inert gas supply conduit line 85 is embedded in the base plate body 45. One end portion of the inert gas supply conduit line 85 is connected to the heat insulation portion 47, and the other end portion is connected to the inert gas supply conduit line 82 provided in the outside of the base plate 81. The inert gas supply conduit line 85 is a conduit line for supplying the inert gas, which is supplied from the inert gas supply device 83 and of which a pressure is adjusted, to the heat insulation portion 47 (space) via the inert gas supply conduit line 82.

The inert gas supply conduit line 82 is disposed in the outside of the base plate 81. One end portion of the inert gas supply conduit line 82 is connected to the inert gas supply conduit line 85, and the other end portion is connected to the inert gas supply device 83. The inert gas supply conduit line 82 is a conduit line for feeding the inert gas, which is supplied from the inert gas supply device 83 and of which a pressure is adjusted, to the inert gas supply conduit line 85.

The inert gas supply device 83 is disposed in the outside of the base plate 81, and is connected to the inert gas supply conduit line 82. The inert gas supply device 83 is a device for supplying the inert gas, of which a pressure is adjusted to be a predetermined pressure, to the heat insulation portion 47 via the inert gas supply conduit lines 82 and 85. As the inert gas supplied by the inert gas supply device 83, for example, helium gas or argon gas may be used.

Likewise, with such a configuration in which the helium gas is used as the inert gas, for example, the helium gas, of which a pressure is adjusted to be a low pressure (for example, a predetermined pressure in the range of 10 Pa to 100 Pa), is supplied to the heat insulation portion 47, it is possible to efficiently heat the base body 21 (specifically, the substrate placement surface 21A) up to a predetermined temperature in a short time. Additionally, for example, with a configuration in which the helium gas, of which a pressure is adjusted to be a high pressure (for example, a predetermined pressure in the range of 10,000 Pa to 100,000 Pa), is supplied to the heat insulation portion 47 and the cooling water flows to the cooling mechanism 46, it is possible to efficiently heat the base body 21 (specifically, the substrate placement surface 21A) up to a predetermined temperature in a short time.

According to the substrate temperature adjusting-fixing device of this embodiment, since the helium gas, of which a pressure is adjusted to be a low pressure (for example, a predetermined pressure in the range of 10 Pa to 100 Pa), is supplied to the heat insulation portion 47, it is possible to efficiently heat the base body 21 (specifically, the substrate placement surface 21A) up to a predetermined temperature in a short time. Accordingly, it is possible to heat the whole substrate 20 up to a predetermined temperature in a shorter time than that of the conventional art.

Additionally, in the substrate temperature adjusting-fixing device 80 according to this embodiment, the uniform heat plate 61 shown in FIG. 4 may be provided between the electrostatic chuck 11 and the base plate 81. Further, the heater portion 66 shown in FIG. 5 may be provided in the base plate body 45 at a portion located between the cooling mechanism 46 and the heat insulation portion 47. Furthermore, the uniform heat plate 61 and the heater portion 66 may be combined with each other.

While the exemplary embodiments of the invention have been described in detail, the invention is not limited to the specific embodiments, but various modifications and substitutions can be made without departing from the scope of the invention described in claims.

The present invention is applicable to the substrate temperature adjusting-fixing device provided with the electrostatic chuck having the base body and the resistance heater embedded in the base body to heat the substrate.

What is claimed is:

1. A substrate temperature adjusting-fixing device comprising:
an electrostatic chuck which includes a base body having a substrate placement surface for placing a substrate thereon, an electrostatic electrode embedded in the base body, and a resistance heater embedded in the base body to heat the substrate,
a base plate which includes a base plate body for supporting the electrostatic chuck and a cooling mechanism embedded in the base plate body to cool the base body, and
a heat insulation portion provided in the base plate body at a portion located between the cooling mechanism and the electrostatic chuck.

2. The substrate temperature adjusting-fixing device according to claim 1, wherein
the cooling mechanism includes a conduit line for allowing a cooling water to flow therethrough and a cooling water introduction portion for introducing the cooling water into the conduit line, and
the heat insulation portion is disposed so as to be opposed to the cooling mechanism.

3. The substrate temperature adjusting-fixing device according to claim 1, wherein
the heat insulation portion is a space formed in the base plate body.

4. The substrate temperature adjusting-fixing device according to claim 3, wherein
the space is in a vacuum state.

5. The substrate temperature adjusting-fixing device according to claim 3, wherein
an inert gas of which a pressure is adjusted to be a predetermined pressure is introduced into the space.

6. The substrate temperature adjusting-fixing device according to claim 5, wherein
the inert gas is a helium gas.

7. The substrate temperature adjusting-fixing device according to claim 1, further comprising:
a uniform heat plate provided between the electrostatic chuck and the base plate.

8. The substrate temperature adjusting-fixing device according to claim 1, further comprising:
a heater portion for heating the substrate provided in the base plate body at a portion located between the heat insulation portion and the cooling mechanism.
